(19) United States
(12) Patent Application Publication
(10) Pub. No.: US 2022/0101149 A1
(43) Pub. Date: Mar. 31, 2022

(54) ASSESSING PROPAGATION OF DISTRIBUTED CONTENT RELEVANT TO A SUBJECT OF FOCUS

(71) Applicant: International Business Machines Corporation, Armonk, NY (US)

(72) Inventors: Shikhar Kwatra, San Jose, CA (US); Adam Lee Griffin, Dubuque, IA (US); Zachary A. Silverstein, Jacksonville, FL (US); Sarbajit K. Rakshit, Kolkata (IN)

(21) Appl. No.: 17/031,914

(22) Filed: Sep. 25, 2020

(51) Int. Cl. G06N 5/02; G06N 3/02; G06F 16/22

(52) U.S. Cl. CPC G06N 5/02; G06F 16/2272; G06N 3/02

(57) ABSTRACT

A computer assesses propagation of distributed content relevant to a subject of focus in an information sharing network. The computer receives a topical content data set containing attribute information for several subjects of assessment. The computer performs a contextual analysis of the attribute information and generates a knowledge corpus with propagation data indexed by subject of assessment. The computer receives distribution content and determines a subject of said distribution content. The computer compares the subject of distribution content to the subjects of assessment to determine whether the distribution content is relevant to a subject of assessment. The computer identifies relevant subjects of assessment as subjects of focus and assesses subject of focus propagation data to determine an importance value for said distribution content. The computer makes a dissemination recommendation for the distribution content based, at least in part, on the importance value.

### BACKGROUND

The present invention relates generally to the field of information sharing, and more specifically, to assessing propagation of distributed content relevant to a subject of focus in an information sharing network.

Modern information distribution opportunities, such as through network news broadcasts and social media posts, can allow topical content to quickly reach a broad audience. Effective and efficient dissemination of information can enhance and enlarge the impact of the message, while ineffective and inefficient dissemination can have the opposite effect.

It is difficult to know what kinds of dissemination will be most effective for a particular message. Unfortunately, the desired audience for a message may not be known by a content distributor at the time of content generation, and even when a desired initial audience is known, audience scope can change. For example, the content of a given message may augmented or receive comments when being passed from initial audience members subsequent recipients, and such changes can broaden or narrow the relevant audience for the message. In some situations, a given message may be distributed and redistributed to several interrelated audiences as the message content changes, and the final audience members may not even be known by the source of the original message.

To ensure a given message achieves the results desired by the message source and to accommodate likely downstream effects, it is important to have perspective regarding an initial audience scope, information regarding ongoing message augmentation, and continued impact as the message is received and redistributed.

### SUMMARY

According to one embodiment, a computer-implemented method for assessing propagation of distributed content relevant to a subject of focus in an information sharing network, includes receiving, by the computer, a topical content data set from a group of topical information sources. The topical content data set includes attribute information for a several subjects of assessment. The computer performs a contextual assessment of the attribute information to generate a knowledge corpus with propagation data indexed according to subjects of assessment. The computer receives distribution content and determining a subject for the distribution content. The computer compares the subject of the distribution content to the subjects of assessment and determines a similarity value. If the similarity value exceeds a relevance threshold, the computer determines that the distribution content is relevant to a subject of assessment. If the computer determines the distribution content is relevant to one of the subjects of assessment, the computer identifying the relevant subject of assessment a subject of focus. The computer assesses the propagation data for the subject of focus and determines an importance value for the distribution content. The computer makes a dissemination recommendation for the distribution content based, at least in part, on the importance value. According to aspects of the invention, the computer propagates the distribution content in accordance with the dissemination recommendation, monitors selected effects of the propagation, and makes a further dissemination recommendation based, at least in part, upon the selected propagation effects. According to aspects of the invention, the computer assesses the distribution content attribute information to identify statistically-likely ancillary propagation results associated with the distribution content and makes a further dissemination recommendation in accordance said identification. According to some aspects of the invention. According to aspects of the invention, the distribution content subject determination for said distribution content is conducted via Latent Dirichlet Allocation. According to aspects of the invention determination of the similarity value is conducted in accordance with a cosine similarity assessment between the subject of focus and the subject for distribution content. According to aspects of the invention, the contextual assessment of the attribute information considers factors selected from a list consisting of type of incident, associated supply chain, associated social content, speed of propagation, location of incident, coordination of users, location specific information included, impact of incident described. According to aspects of the invention, the attribute information is generated by assessing the topical content data set via bidirectional long sort-term memory text input constant neural network analysis. According to aspects of the invention, wherein said importance value for said distribution content is selected from list consisting of anticipated distribution metrics, message context, and post effectiveness.

According to another embodiment a system to assess propagation of distributed content relevant to a subject of focus in an information sharing network, which comprises: a computer system comprising a computer readable storage medium having program instructions embodied therewith, the program instructions executable by a computer to cause the computer to: receive a topical content data set from a plurality of topical information sources, said topical content data set containing attribute information for a plurality of subjects of assessment; perform a contextual assessment of said attribute information to generate a knowledge corpus containing propagation data indexed by subject of assessment; receiving distribution content and determine a subject of said distribution content; comparing said subject of said distribution content to said subjects of assessment to determine a similarity value; responsive to said similarity value exceeding a relevance threshold, determine that said distribution content is relevant to one of said subjects of assessment; responsive to determining said distribution content is relevant to one of said subjects of assessment, identify said relevant subject of assessment as a subject of focus; assess the propagation data for said subject of focus and determine an importance value for said distribution content; make a dissemination recommendation for said distribution content based, at least in part, on said importance value.

According to another embodiment, a computer program product to assess propagation of distributed content relevant to a subject of focus in an information sharing network, the computer program product comprising a computer readable storage medium having program instructions embodied therewith, the program instructions executable by a computer to cause the computer to: receive, using said computer, a topical content data set from a plurality of topical information sources, said topical content data set containing attribute information for a plurality of subjects of assessment; perform, using said computer, a contextual assessment of said attribute information to generate a knowledge corpus containing propagation data indexed by subject of assessment; receiving, using said computer, distribution content and determine a subject of said distribution content; comparing, using said computer, said subject of said distribution content to said subjects of assessment to determine a similarity value; responsive, using said computer, to said similarity value exceeding a relevance threshold, determine that said distribution content is relevant to one of said subjects of assessment; responsive, using said computer, to determining said distribution content is relevant to one of said subjects of assessment, identify said relevant subject of assessment as a subject of focus; assess, using said computer, the propagation data for said subject of focus and determine an importance value for said distribution content; make, using said computer, a dissemination recommendation for said distribution content based, at least in part, on said importance value.

Some aspects of the present disclosure recognize and address the shortcomings and problems associated with establishing an initial audience for message distribution. Other aspects of the invention help maintain an appropriate audience scope in keeping with message content changes. Still other aspects of the invention help accommodate expected downstream effects of message dissemination. Aspects of the invention provide predictive and proactive analysis regarding the propagation of messages associated with selected topics. Aspects of the invention can assist with tracking of content delivered through real-time communications or near-real-time communications among participants in a supply chain with real-time communications. Aspects of the invention can also assist with assessing and monitoring a distribution network of product flows and monitor how upstream inputs may impact or influence downstream events.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for computer-implemented propagation assessment for a message related to a subject of interest in an information sharing network.

FIG. 2 is a flowchart illustrating a method, implemented using the system shown in FIG. 1, of assessing propagation of a message related to subject of interest in an information sharing network according to aspects of the invention.

FIG. 3 is a flowchart illustrating aspects of a dissemination recommendation evaluation module implemented using the system shown in FIG. 1.

FIG. 4 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

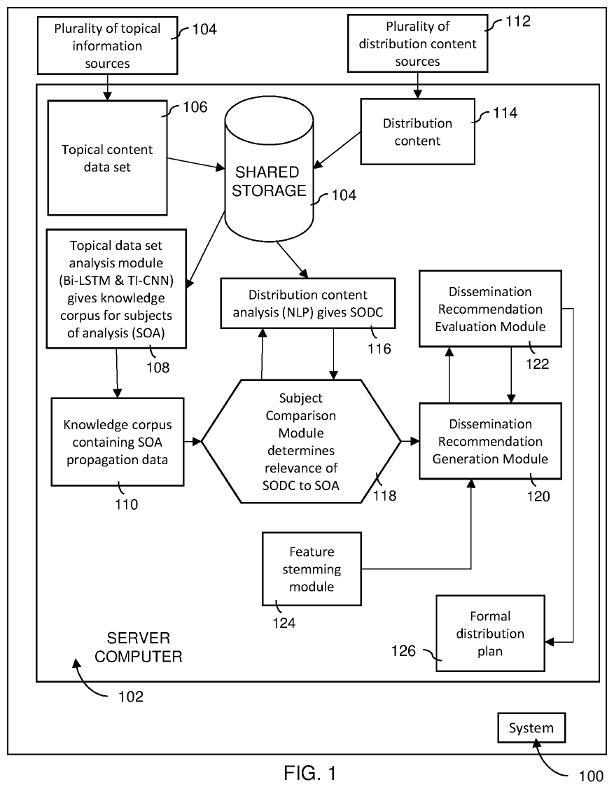

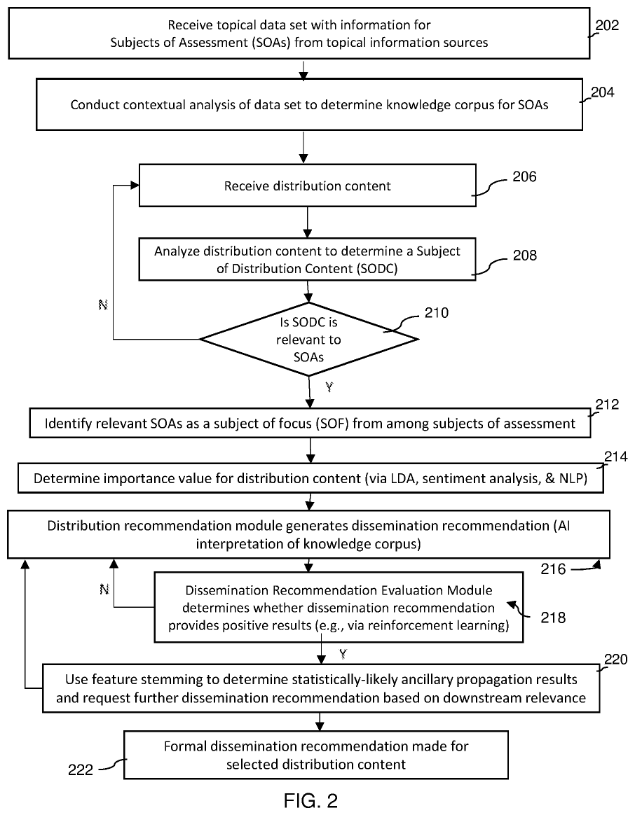

Now with combined reference to the Figures generally and with particular reference to FIG. 1 and FIG. 2, an overview of a method 200 for assessing the propagation of a message related to a subject of focus in an information sharing network usable within a system 100 as carried out by a server computer 102 having optionally shared storage 104 and aspects that evaluate message propagation. The server computer 102 communicates with a variety of topical information sources 104 (e.g., newspapers, online content providers, TV news, and other sources) and receives a data set 106 of desired information. The data set 106 can include active and/or historical incidents and content from the topical information sources 104, as well as social media networks, network/supply chain messages, and other inputs generated during a pre-determined event timeline. In some settings (e.g., such as from social media sources), the data set 106 may also include influential comments for various messages.

A data set analysis module 108, as will be more fully described below, creates a knowledge corpus 110 of propagation data by correlating different aspects of messages, including types of incidents reported, associated supply chain and social media content, speed of propagation of the content, location of reported incidents, positive and negative impact of the incidents. Other message aspects can also be processed when generating the knowledge corpus, as selected by one skilled in this art. Subjects associated with the messages 106 for which the knowledge corpus is created are known as Subject of Analysis (SOAs).

The server computer 102 also communicates with distribution content sources 112 that have content 114 which is submitted for distribution, and the server computer analyzes distribution content (e.g., from these sources just before distribution occurs, while the content is queued for distribution). The group of distribution content sources 112 may include sources from the group of sources 104 that also provide topical content 106, although both groups could be different, as selected in accordance with the judgment of one skilled in this art. The server computer 102 also includes aspects 116 that analyze the distribution content 114 to determine the Subject of the Distribution Content (SODC).

The server computer 102 includes a Subject Comparison Module (SCM) 118 that assesses whether the SODC is relevant to the topical content SOAs. If, as discussed more fully below, the SCM 118 determines the SODC is relevant to one or more of the SOAs, the server computer 102 identifies the relevant SOAs as Subjects of Focus (SOFs) and determines an importance value for the distribution content 114 associated with the SOFs.

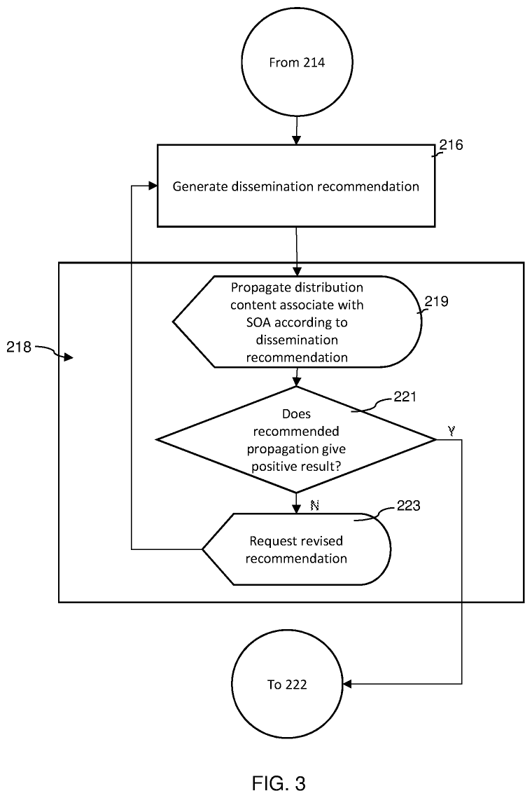

The server computer 102 includes a Dissemination Recommendation Generation Module 120 that generates a dissemination recommendation for the analyzed distribution content 114 associated with the SOFs. According to embodiments of the invention, the dissemination recommendation is provided to the distribution content sources 112, and the distribution content 114 associated with the SOFs is propagated in accordance with the recommendation provided. With continued reference to FIG. 1 and additional reference to FIG. 2 and FIG. 3, the sever computer 102 includes a Distribution Recommendation Evaluation Module (DREM) 122 that, as described more fully below, assesses the results of dissemination distribution content 114 associated with the SOFs in accordance with the dissemination recommendation. If the DREM 122 determines that following the dissemination recommendation provides negative results within a monitored information network, the DREM iteratively provides behavior feedback to the DRGM 120 and requests the DRGM to provide a revised dissemination recommendation. When the DREM 122 determines that following a dissemination recommendation (either original or revised) provides positive results within a monitored information network, aspects 126 of the server computer 102 use the currently-provided dissemination recommendation to generate a formal distribution plan for the distribution content 114 associated with the SOFs. As used herein, the term monitored information network refers to portions of the topical information sources 104 and distribution content sources 112 affected by dissemination of the distribution content 114 associated with the SOFs.

The server computer 102 also includes a feature stemming module 124 which, as will be described more fully below, can predict statistically-likely outcomes (e.g., such as likely location of an incident discussed in distributed content associated with SOFs, the likely timeframe of occurrence for such incidents, and possible downstream impacts from the incident, and so forth) associated as distributed content is disseminated. Predicted outcome output from the feature stemming module 124 may be provided to the DRGM 120 and used to augment or refine the dissemination recommendations made by the DRGM.

Now, with continued reference to FIG. 1, and with additional reference to FIG. 2, aspects of the method 200 for assessing propagation of a message or other distributed content relevant to a subject of focus in an information sharing network usable according to aspects of the present invention will be described. At block 202, the server computer 102 receives data set 106 of topical information. This information comes from a variety of sources, including various public reports of incidents from local newspapers, news broadcasts, and other similar public sources. It is noted that privately-sourced information may also be used, when proper consent is given for it use. If consent is given, the consent must adhere to the legal standards required for its use. Examples of such standards include, but are not limited to, using the private information only for the purpose and time period for which permission was granted. When such private information is used, it is preferably done in accordance with a formally-documented opt-in program, in which users granting permission for use of content (e.g., social media posts, comments, data, and other items for which the user may legally provide permission for use) explicitly provide permission, along with details describing allowable use conditions.

The server computer 102 at block 204, via the data set analysis module 108, conducts a contextual analysis of the data set 106 to generate a knowledge corpus that contains propagation information (e.g., incident location, time, and severity) of selected topics or subjects. The subjects for which propagation data are generated are known collectively as Subjects of Analysis (SOAs). With proper permission, provided as described above, propagation data may also include information from social networks, including the information regarding time and pacing of content distributed within identified time ranges associated with incidents described in the content. Other sources of topical information also, with proper permission, may include supply chain servers and other data sources that show the interrelated connections of participants related to each other as up and downstream providers and producers, as well as those providers who occupy parallel spaces in a given supply chain. AI algorithms, including bi-directional long, short-term memory (Bi-LSTM) arrangements may be used alone, or in combination with complementary analysis algorithms, such as Text Input & Convolutional Neural Network (TI-CNN) methods, to provide comprehensive contextual analysis of content. Although the forward- and backward-looking features of Bi-LSTMs and the text extraction capabilities found in TI-CNN are suitable for the analysis conducted at block 204, other AI analysis algorithms can be selected by a user skilled in this art. It is noted that while specific network structures can also be selected by one skilled in this art, Hopfield Networks (HNN) and Gated Recurrent Units/Networks (GRU) are particularly appropriate.

At block 206, the server computer 102 collects (or otherwise receives) queued-for-dissemination distribution content 114 from a variety of distribution content sources 112, which as noted elsewhere, may (but need not) include providers that also provide already-published topical information for the topical data set 106. The server computer 102 may obtain this content using automated routines (often known as scrubbing or web-crawling routines), such as those collected in the publicly-accessible on-line resource known as the “BeautifulSoup” library.

At block 208, the server computer 102 analyzes the collected distribution content 114 to determine a Subject of the Distributed Content (SODC). Various methods may be used to determine the SODC, and Natural Language Processing (NLP) is particularly appropriate, given the variety of distribution content sources which must be accommodated.

Once the server computer 102 determines the SODC, the server computer 102, via the SCM 118 at block 210, iteratively compares the SODC to the various SOAs represented in the knowledge corpus to identify whether any SOAs are relevant to the SODC. The sever computer 102 preferably uses a Cosine Similarity analysis to determine a similarity value for the SODC and a compared SOA. Although many approaches could be used for this comparison, including Euclidean distance (i.e., number of words in common) routines or other similar routines selected by one of skill in this art, Cosine Similarity analysis is preferred, due to its accuracy even with large documents.

Once the SODC and SOA are compared, the server computer 102, at block 212, identifies the compared SOA as a Subject of Focus (SOF), if the similarity value exceeds a similarity threshold. Although the similarity threshold may be selected to require varying degrees of similarity to indicate relevance, according to aspects of the invention, the server computer 102 will, at block 210 consider a Cosine Similarity analysis that demonstrates 90% or more similarity between a SODC and a compared SOA to exceed the similarity threshold. As noted above, when the SODC and a compared SOA exhibit a similarity value exceeding the similarity threshold, the server computer will deem the SODC relevant to the compared SOA at block 210, and the compared SOA will be labeled a SOF at block 212. If the sever computer 102 determines that the similarity value for a given SODC and a compared SOA does not exceed the similarity threshold, the analysis flow returns to block 206, where new distribution content 206 is received, an associated SODC is determined, and SODC and SOA similarity is repeated. It is noted that distribution content and topical content could be compared directly without discrete steps to separately determine a SODC and SOAs.

The server computer 102, at block 214, will compute an importance value for the distributed content 114 associated with an identified SOA by considering the similarity value generated in block 210, SOA propagation data from the knowledge corpus 110, along with any extenuating circumstances (e.g., such as a high volume or swift propagation of distribution content associated with a given SOA in a short period of time, severity of message, high volume of distribution content related to a single SOA coming from a large number of geographic regions, or the especially noteworthy reputation a given source's impact) for the distribution content associated with the analyzed SOA. AI modeling, again including BI-LSTM and TI-CNN methods, is used to complete this importance value assessment. The results of these models are assessed, and importance is determined, through use of known unsupervised learning algorithms, such as Latent Dirichlet Allocation (LDA) via Natural Language Processing (NLP) and sentiment analysis, for the distributed content. As used herein, the term importance value indicates the likely impact of disseminating certain distribution content 114 throughout an information network. The importance value represents how a given piece of distribution content, based on deep AI leaning, black box analysis, and correlation to similar pieces of distribution content previously in comparable circumstances, is likely to impact the relevant information network in present or near-present time.

At block 216, the server computer 102 via the DRGM 120, generates a recommended dissemination recommendation for the given distribution content based on the importance value generated in block 214. As noted above, the server computer 102 receives distribution content as is it queued for distribution, and the recommendation made in block 216 applies known AI modelling algorithms in the fashion known to those skilled in this art to recommend either disseminating the relevant distribution content 114 as intended, increasing distribution of the distribution content to reach a wider audience, or reducing the distribution to reach a narrowed audience. The tendency of the server computer 102 to maintain, increase, or reduce the intended audience can be adjusted by one skilled in this art with a scope tendency bias that will affect the output of the DRGM 120. When the scope tendency bias is programmed to favor a broad, typical, or narrow audience, the DRGM will tend to recommend, respectively, distributing the distribution content to standard, broader, or narrowed audience compared to that originally considered.

According to aspects of the invention, the server computer 102 via the DREM 122, determines, as shown schematically at block 218, whether the dissemination recommendation yields positive results. If the DREM 122, as will be discussed by fully below, determines the generates positive results, the server computer 102 recommends the current dissemination recommendation be included as part of a formal distribution plan. If the DREM 122, determines that the dissemination recommendation if generating negative results, the DREM requests a revised recommendation from the DRGM 120, with dissemination recommendation generation and evaluation cycle continuing interval until the DREM 122 identifies positive results.

As used herein, the terms positive and negative results, respectively mean results that either support or counter the stated goals of a given information network regarding content distribution. Accordingly, the terms are not absolutes, they vary in accordance with the distribution goals of a given information network. For example, some networks may favor large-scale distribution, and positive results for that network would support that goal, while negative results would generate small-scale distribution. Other information networks might favor small-scale distribution and positive results for that network would support that goal, while negative results would promote large-scale distribution. Other network goals may vary, and the DREM 122 of the present invention can accommodate many different goal types.

This iterative review analysis conducted by the DREM 122 uses an iterative reinforcement learning algorithm which is shown more clearly in FIG. 3 and which will now be discussed further. The dissemination recommendation made in block 216 is passed to the DREM 122 (shown schematically in FIG. 3 as compound block 218). More specifically, the server computer 102 at block 219, propagates the distribution content associated with the SOA to the intended audience in accordance with the dissemination recommendation made by the DRGM 120. At block 221, the server computer 102 determines whether the actual results are in line with stated goals for the hosting information network, then the results are deemed positive, and the current dissemination recommendation is passed forward out of the DREM 122 for further downstream use by the server computer 102. If the server computer 102 determines whether the actual results are counter to stated goals for the hosting information network, then the results are deemed negative, the DREM 122, at block 223, updates the DRGM 120 and requests a revised dissemination recommendation. Process flow returns to the updated DRGM 120 at block 216, where a revised dissemination recommendation is generated and returned to the DRGM 218 for the next round iterative analysis.

Now returning to FIG. 2, the server computer 102 also includes, at block 220, an optional feature stemming module 124. Depending on the permissions granted and nature of the data collected in blocks 202 and 206, the feature stemming module 124 may provide information about downstream distribution effects not represented directly in the knowledge corpus 110 and which are not, therefore, included in the original dissemination recommendation. For example, some co-related posts, events, or contents might spread in way not shown even with deep learning analysis of the knowledge corpus, often these tendencies to spread are only known in a statistical sense, in that deep leaning analysis shows a likelihood of 50% or more that such spreading occurrences will happen, based on similarities that are apparent after the initial dissemination recommendation is made. Some messages can contribute to and increase propagation speed of other messages, and this might not be captured in the topical data propagation data before a dissemination recommendation is made, and through reinforcement learning, the effect of complementary incidents is captured and included as part of a revised importance value for a given piece of distribution content. This revised importance value can be passed along to the DRGM 120 for use when determining a proper dissemination recommendation. This allows dissemination recommendations to be made in accordance with traditional and predictive, deep learning AI techniques, while allowing for augmentation with updates that are proactively tied to actual impact seen not only in the primary incidents as described, but also to complementary incidents whose connection might only be known after an initial distribution audience is selected.

When no stemming feature augmentations are available for passing to the DRGM, and when the DREM 122 determines that positive results are generated by the current dissemination recommendation, the server computer 102 stops iterative recommendation evaluation. Process flow moves on to block 222, where the server computer 102 adopts the current dissemination recommendation as a formal current dissemination recommendation to be included in a formal distribution plan to propagate the distribution content 114 associated with the SOF.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

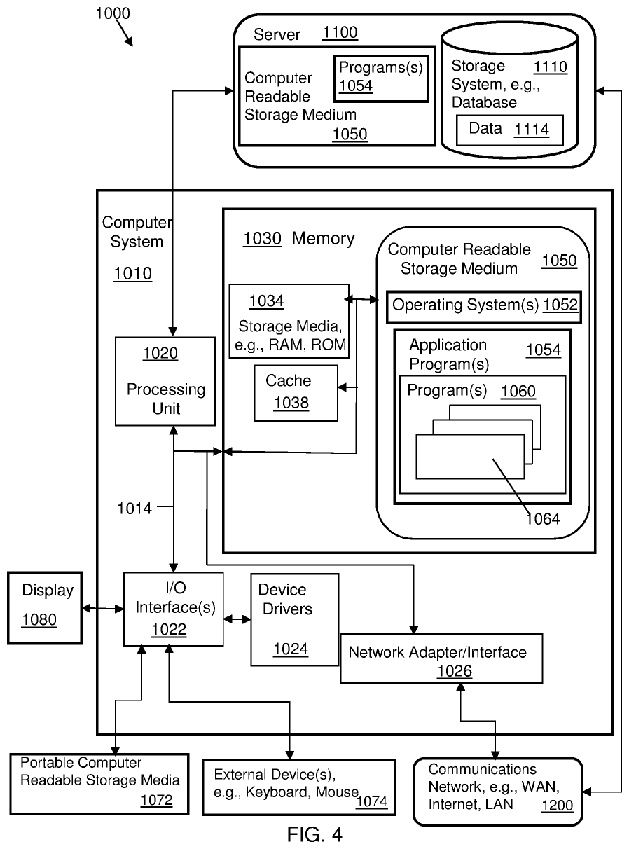

Referring to FIG. 4, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 8) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

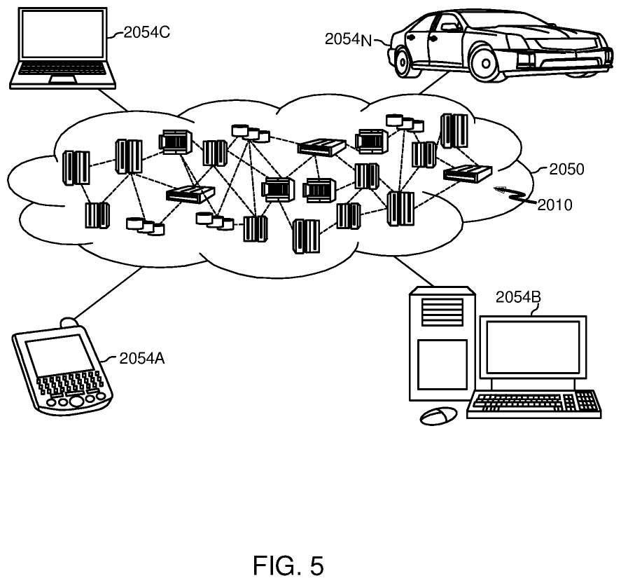

Referring now to FIG. 5, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

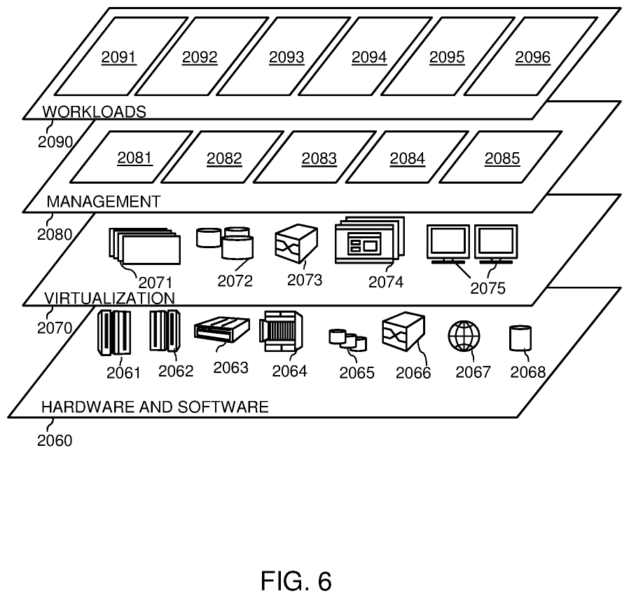

Referring now to FIG. 6, a set of functional abstraction layers provided by cloud computing environment 2050 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and assess propagation of distributed content relevant to a subject of focus in an information sharing network 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method to assess propagation of distributed content relevant to a subject of focus in an information sharing network, comprising:
receiving, by said computer, a topical content data set from a plurality of topical information sources, said topical content data set containing attribute information for a plurality of subjects of assessment;
performing, by said computer, a contextual analysis of said attribute information to generate a knowledge corpus containing propagation data indexed by subject of assessment;
receiving, by said computer, distribution content and determining, by said computer, a subject of said distribution content;
comparing, by said computer, said subject of said distribution content to said subjects of assessment to determine a similarity value;
responsive to said similarity value exceeding a relevance threshold, determining, by said computer, that said distribution content is relevant to one of said subjects of assessment;
responsive to determining said distribution content is relevant to one of said subjects of assessment, identifying, by said computer, said relevant subject of assessment as a subject of focus;
assessing, by said computer, the propagation data for said subject of focus and determining, by said computer, an importance value for said distribution content;
making, by said computer, a dissemination recommendation for said distribution content related to said subject of focus based, at least in part, on said importance value.

2. The method according to claim 1, further comprising:
propagating, by said computer, said distribution content in accordance with said dissemination recommendation; and
monitoring, by said computer, selected effects of said propagation and making, by said computer, a further dissemination recommendation based, at least in part, upon said selected effects of said propagation.

3. The method according to claim 1, further comprising:
assessing, by said computer, said attribute information for said distribution content to identify statistically-likely ancillary propagation results associated with said distribution content and making, by said computer, a further dissemination recommendation in accordance said identification.

4. The method according to claim 1, wherein said subject determination for said distribution content is conducted via Latent Dirichlet Allocation.

5. The method according to claim 1, wherein said determination of said similarity value is conducted in accordance with a cosine similarity assessment between said subject of focus and said subject for said distribution content.

6. The method according to claim 1, wherein said contextual analysis of said attribute information considers factors selected from a list consisting of type of incident, associated supply chain, associated social content, speed of propagation, location of incident, coordination of users, location specific information included, impact of incident described.

7. The method according to claim 1, wherein said attribute information is generated by assessing said topical content data set via bidirectional long sort-term memory text input constant neural network analysis.

8. The method according to claim 1, wherein said importance value for said distribution content is selected from list consisting of anticipated distribution metrics, message context, and post effectiveness.

9. A system to assess propagation of distributed content relevant to a subject of focus in an information sharing network, which comprises:
a computer system comprising a computer readable storage medium having program instructions embodied therewith, the program instructions executable by a computer to cause the computer to:
receive a topical content data set from a plurality of topical information sources, said topical content data set containing attribute information for a plurality of subjects of assessment;
perform a contextual analysis of said attribute information to generate a knowledge corpus containing propagation data indexed by subject of assessment;
receiving distribution content and determine a subject of said distribution content;
comparing said subject of said distribution content to said subjects of assessment to determine a similarity value;
responsive to said similarity value exceeding a relevance threshold, determine that said distribution content is relevant to one of said subjects of assessment;
responsive to determining said distribution content is relevant to one of said subjects of assessment, identify said relevant subject of assessment as a subject of focus;
assess the propagation data for said subject of focus and determine an importance value for said distribution content; and
make a dissemination recommendation for said distribution content related to said subject of focus based, at least in part, on said importance value.

10. The system according to claim 9, comprising further instructions causing the computer to:
propagate said distribution content in accordance with said dissemination recommendation; and
monitor selected effects of said propagation and making, by said computer, a further dissemination recommendation based, at least in part, upon said selected effects of said propagation.

11. The system according to claim 9, comprising further instructions causing the computer to:
assess said attribute information for said distribution content to identify statistically-likely ancillary propagation results associated with said distribution content and make a further dissemination recommendation in accordance said identification.

12. The system according to claim 9, wherein said subject determination for said distribution content is conducted via Latent Dirichlet Allocation.

13. The system according to claim 9, wherein said determination of said similarity value is conducted in accordance with a cosine similarity assessment between said subject of focus and said subject for said distribution content.

14. The system according to claim 9, wherein said contextual analysis of said attribute information considers factors selected from a list consisting of type of incident, associated supply chain, associated social content, speed of propagation, location of incident, coordination of users, location specific information included, impact of incident described.

15. The system according to claim 9, wherein said attribute information is generated by assessing said topical content data set via bidirectional long sort-term memory text input constant neural network analysis.

16. The system according to claim 9, wherein said importance value for said distribution content is selected from list consisting of anticipated distribution metrics, message context, and post effectiveness.

17. A computer program product to assess propagation of distributed content relevant to a subject of focus in an information sharing network, the computer program product comprising a computer readable storage medium having program instructions embodied therewith, the program instructions executable by a computer to cause the computer to:
receive, using said computer, a topical content data set from a plurality of topical information sources, said topical content data set containing attribute information for a plurality of subjects of assessment;
perform, using said computer, a contextual analysis of said attribute information to generate a knowledge corpus containing propagation data indexed by subject of assessment;
receiving, using said computer, distribution content and determine a subject of said distribution content;
comparing, using said computer, said subject of said distribution content to said subjects of assessment to determine a similarity value;
responsive, using said computer, to said similarity value exceeding a relevance threshold, determine that said distribution content is relevant to one of said subjects of assessment;
responsive, using said computer, to determining said distribution content is relevant to one of said subjects of assessment, identify said relevant subject of assessment as a subject of focus;
assess, using said computer, the propagation data for said subject of focus and determine an importance value for said distribution content; and
make, using said computer, a dissemination recommendation for said distribution content related to said subject of focus based, at least in part, on said importance value.

18. The computer program product according to claim 17, comprising further instructions causing the computer to:
propagate, using said computer, said distribution content in accordance with said dissemination recommendation; and
monitor, using said computer, selected effects of said propagation and making, by said computer, a further dissemination recommendation based, at least in part, upon said selected effects of said propagation.

19. The computer program product according to claim 17, comprising further instructions causing the computer to:
assess, using said computer, said attribute information for said distribution content to identify statistically-likely ancillary propagation results associated with said distribution content and make a further dissemination recommendation in accordance said identification.

20. The computer program product according to claim 17, wherein said subject determination for said distribution content is conducted via Latent Dirichlet Allocation.
